(19) United States
(12) Patent Application Publication
(10) Pub. No.: US 2019/0185728 A1
(43) Pub. Date: Jun. 20, 2019

(54) DOWNHOLE FLUIDS HAVING BALANCED RHEOLOGICAL PROPERTIES, METHODS OF MANUFACTURE, AND APPLICATIONS THEREOF

(71) Applicant: Dennis Clapper, Houston, TX (US)

(72) Inventor: Dennis Clapper, Houston, TX (US)

(73) Assignee: Baker Hughes, a GE company, LLC, Houston, TX (US)

(21) Appl. No.: 15/847,984

(22) Filed: Dec. 20, 2017

(51) Int. Cl. C09K 8/03; C09K 8/035; C09K 8/70

(52) U.S. Cl. CPC C09K 8/032; C09K 2208/10; C09K 8/70; C09K 8/035

(57) ABSTRACT

A method of treating a wellbore, a subterranean formation, or a combination thereof comprises introducing into the wellbore, the subterranean formation, or a combination thereof a treatment fluid comprising: a liquid carrier; a plurality of micron-sized primary particles; a plurality of nano-sized secondary particles disposed on a surface of the primary particles; and a solvent that is immiscible with the liquid carrier and coats the primary particles; the secondary particles and the solvent being selected such that the treatment fluid has a reduced rheological property as compared to an otherwise identical reference fluid that does not contain the solvent or the secondary particles, and performing a drilling operation, a completion operation, a workover operation, an abandonment operation, or a combination comprising at least one of the foregoing.

### BACKGROUND

A major challenge for downhole fluid design is the control of rheological properties associated with high solids loading required of many downhole fluids. For example, high density minerals are often added to drilling fluids in order to control formation pressure. Barite is the commonly used weighting material; and barite additions to drilling fluids can approach 50% by volume. This loading of finely ground barite along with other fluid components including incorporated drill solids can produce an extremely viscous fluid with undesirable rheological properties such as high viscosity, high yield point, and high gel strengths. Conventional methods of reducing these rheological properties include dilution, using a weighting agent with a higher density, adjusting oil-water-ratio for oil-base fluids, or using deflocculants, wetting agent, and the like. Alternative methods to control the rheological properties of downhole fluids are desired in the art.

### SUMMARY

A downhole treatment fluid having a reduced rheological property comprises a liquid carrier; a plurality of micron-sized primary particles; a plurality of nano-sized secondary particles disposed on a surface of the primary particles; and a solvent that is immiscible with the liquid carrier and coats the primary particles, wherein the treatment fluid is a drilling fluid, a drill-in fluid, a fracturing fluid, a servicing fluid, or a gravel pack fluid; and the primary particles and the solvent are selected such that the treatment fluid has a reduced rheological property as compared to an otherwise identical reference fluid that does not contain the solvent or the secondary particles.

In an embodiment, a method of reducing a rheological property of a downhole treatment fluid comprises combining a first fluid with a solvent and a plurality of nano-sized secondary particles, the first fluid comprising a plurality of micron-sized primary particles and a liquid carrier which is immiscible with the solvent; coating the primary particles with the solvent; and disposing the secondary particles on a surface of the primary particles, wherein the treatment fluid is a drilling fluid, a drill-in fluid, a fracturing fluid, a servicing fluid, or a gravel pack fluid; and the secondary particles and the solvent are selected such that the treatment fluid has a reduced rheological property as compared to an otherwise identical reference fluid that does not contain the solvent or the secondary particles.

In another embodiment, a method of reducing a rheological property of a downhole treatment fluid comprises contacting a plurality of micron-sized primary particles with a solvent and a plurality of nano-sized secondary particles; coating the primary particles with the solvent; disposing the secondary particles on a surface of the primary particles to provide a modifier composition; combining the modifier composition with a liquid carrier immiscible with the solvent to form a downhole treatment fluid which is a drilling fluid, a drill-in fluid, a fracturing fluid, a servicing fluid, or a gravel pack fluid; wherein the secondary particles and the solvent are selected such that the treatment fluid has a reduced rheological property as compared to an otherwise identical reference fluid that does not contain the solvent or the secondary particles.

A method of treating a wellbore, a subterranean formation, or a combination thereof comprises introducing into the wellbore, the subterranean formation, or a combination thereof the treatment fluid as described above, and performing a drilling operation, a completion operation, a workover operation, an abandonment operation, or a combination comprising at least one of the foregoing.

### DETAILED DESCRIPTION

It has been found that the rheological properties of downhole treatment fluids can be reduced by using certain nanoparticles and solvents. The discovery allows for the manufacture of various downhole treatment fluids having reduced rheological properties such as reduced viscosity, reduced yield point, and/or reduced gel strength. The treatment fluids can be oil based or aqueous based and contain a liquid carrier, micron-sized primary particles, nano-sized secondary particles disposed on a surface of the primary particles, and a solvent that coats the primary particles. Without wishing to be bound by theory, it is believed that the solvent and the secondary particles change the hydrophobicity or oleophobicity of the primary particles thus reducing the rheological properties of the treatment fluids containing the primary particles.

As used herein, the primary particles have an average particle size of about 5 microns to about 500 microns or about 10 microns to about 400 microns or about 30 microns to about 250 microns. The primary particles can include solid particles suspended in downhole treatment fluids known in the art. Exemplary primary particles include weighing agents such as barite, hematite, galena, ilmenite, siderite, calcium carbonate, or a combination comprising at least one of the foregoing.

The amount of the primary particles depends on the specific downhole treatment fluids formulated and the materials for the primary particles. In general, the primary particles can be present in an amount of about 1 to about 60 volume % or about 5 volume % to about 40 volume % based on the total volume of the treatment fluids.

The secondary particles are generally nanoparticles. Nanoparticles are particles that have at least one dimension that is less than 1 micron. In an embodiment, the secondary particles comprise nanoparticles having an average particle size of about 5 nanometers to about 500 nanometers, about 10 nanometers to about 250 nanometers, or about 20 nanometers to about 150 nanometers. When measured under the same conditions, the ratio of the average particle size of the primary particles relative to the average particle size of the secondary particles is about 8,000:1 to about 100:1, or about 5,000:1 to about 250:1, or about 5,000:1 to about 500:1. The nanoparticles can include spherical or ellipsoidal nanoparticles, nanorods, nanotubes, nanowhiskers, nanoribbons, nanosheets, nanoplatelets, or the like, or a combination thereof. In one embodiment, the nanorods, nanotubes, nanowhiskers, nanoribbons, and nanosheets can have branches if desired.

Exemplary secondary particles include inorganic carbonate nanoparticles, carbonaceous nanoparticles, metal oxide nanoparticles, ceramic nanoparticles, composite nanoparticles, or a combination comprising at least one of the foregoing.

Examples of inorganic carbonate nanoparticles include calcium carbonate nanoparticles.

Examples of carbonaceous nanoparticles are fullerenes, carbon nanotubes, metal coated carbon nanotubes, graphite nanoparticles, graphene nanoparticles, or the like, or a combination comprising at least one of the foregoing nanoparticles. In another embodiment, the nanoparticles can be composite nanoparticles. Exemplary composite nanoparticles include but are not limited to carbonaceous nanoparticles mixed with nano-clay and/or metal oxide nanoparticles, and/or ceramic nanoparticles.

The metal oxide nanoparticles can comprise magnesium oxide nanoparticles, zirconium oxide nanoparticles, zinc oxide (ZnO) nanoribbons, tin dioxide (SnO₂) nanoribbons, indium (III) oxide (In₂O₃) nanowires, cadmium oxide (CdO) nanoribbons, gallium (III) oxide (Ga₂O₃) nanoribbons, tungsten oxide (WO₃) nanowires, titanium dioxide (TiO₂) nanotubes, silicon dioxide spherical or ellipsoidal nanoparticles, aluminum oxide spherical or ellipsoidal nanoparticles, zirconium oxide spherical or ellipsoidal nanoparticles, titanium dioxide spherical or ellipsoidal nanoparticles, or the like, or a combination thereof. While the foregoing metal oxide nanoparticles are listed in one form, other commercially available forms having the same chemical composition can be used. For example, while the zinc oxide above is listed as being in the form of nanoribbons, it can also be used in the form of nanotubes, nanowires, nanorods or nanosheets, if such shapes are commercially available.

In a specific embodiment, the secondary particles comprise nano calcium carbonate, nano magnesium oxide, carbon nanotubes, or a combination comprising at least one of the foregoing.

The secondary particles can be present in an amount of about 0.001 wt % to about 15 wt % or about 0.005 wt % to about 10 wt % based on the total weight of the treatment fluids.

The liquid carrier and solvent comprise water or oil. In an embodiment, the liquid carrier comprises water and the solvent comprises an oil. In another embodiment, the liquid carrier comprises an oil and the solvent comprises water. The oil can be a diesel oil, a paraffin oil, a natural oil such as those derived from vegetables or animals, a mineral oil, a crude oil, a gas oil, kerosene, an aliphatic solvent, an aromatic solvent, a synthetic oil, or a combination comprising at least one of the foregoing.

An exemplary liquid carrier is brine. The brine can be, for example, seawater, produced water, completion brine, or a combination thereof. The properties of the brine can depend on the identity and components of the brine. Seawater, as an example, contains numerous constituents such as sulfate, chloride, and trace metals, in addition to halide-containing salts. On the other hand, produced water can be water extracted from a production reservoir (e.g., hydrocarbon reservoir), produced from the ground. Produced water is also referred to as reservoir brine and often contains many components such as barium, strontium, and heavy metals as well as halide salts. In addition to the naturally occurring brines (seawater and produced water), completion brine can be synthesized from fresh water by the addition of various salts such as NaCl, CaCl₂, or KCl to increase the density of the brine to a value such as 10.6 pounds per gallon of CaCl₂ brine. Completion brines can provide a hydrostatic pressure optimized to counter the reservoir pressure downhole. The above brines can be modified to include an additional salt. In an embodiment, the additional salt included in the brine is NaCl, KCl, NaBr, MgCl₂, CaCl₂, CaBr₂, ZnBr₂, NH₄Cl, sodium formate, potassium formate, cesium formate, and the like. The salt can be present in the brine in an amount from about 0.5 wt. % to about 50 wt. %, specifically about 1 wt. % to about 40 wt. %, and more specifically about 1 wt. % to about 25 wt. %, based on the weight of the brine.

The liquid carrier is used in the downhole treatment fluids in amounts of about 20 volume % to about 99 volume %, specifically about 40 to about 80 volume %, and more specifically about 50 to about 70 volume %, based on the total volume of the downhole treatment fluids.

The treatment fluids can further comprise a dispersing agent. (also referred to as “dispersant”) The rheological properties of the treatment fluids can be further reduced by using a dispersing agent. The dispersant can be present in an amount of 0.001 volume % to about 10 volume % or about 0.01 volume % to about 5 volume %, based on the total volume of the treatment fluids.

Any known dispersants for downhole treatment fluids can be used. Exemplary dispersants include alkyl sulfosuccinates, nonylphenoxy-poly(ethyleneoxy)ethanol, polyethyleneglycol C₈₋₁₀ alkyl ethers, polyacrylates, acrylate-sulfonate copolymers, petroleum sulfonic acid derivatives, lignin sulfonic acid derivatives, naphthalene sulfonic acid derivatives, salts of these derivatives and formaldehyde condensates of these derivatives, or a combination comprising at least one of the foregoing.

Some exemplary dispersants are disclosed in U.S. Pat. No. 9,828,560. Petroleum sulfonic acid derivatives, lignin sulfonic acid derivatives, naphthalene sulfonic acid derivatives, salts of these derivatives and formaldehyde condensates of these derivatives are further described in U.S. Pat. No. 4,330,301. A formaldehyde condensate of a sulfonation product of naphthalene or a naphthalene derivative having an alkyl group or alkenyl group as the substituent, or a salt thereof is specifically mentioned. As defined herein, the alkyl and alkylene groups have from 1 to 6 carbon atoms. Further, it is suitable to use naphthalene or a substituted naphthalene containing an alkyl or alkenyl substituent having up to 6 carbon atoms on the average, and mixtures of such naphthalene compounds. For example, formaldehyde condensates of naphthalene sulfonic acid, butylnaphthalene sulfonic acid and mixtures thereof are acceptable. It is also suitable that the degree of condensation is from about 1.2 to about 30, in another non-limiting embodiment from about 1.2 to about 10.

Known additives typically used in downhole treatment fluids can also be used provided that the additives do not adversely affect the desired properties of the downhole treatment fluids. The treatment fluids can be a drilling fluid, a drill-in fluid, a fracturing fluid, a servicing fluid, or a gravel pack fluid. In an embodiment, the treatment fluid is a drilling fluid. Additives for drilling fluids include weighting materials, rheology modifiers, viscosifiers, defoamers, fluid loss agents, lubricants, shale stabilizers or a combination comprising at least one of the foregoing.

As disclosed herein, the treatment fluids have a relatively low viscosity in comparison to fluids that do not contain the solvent or the secondary particles. The lower viscosity allows for easier pumping of the treatment fluids through the equipment used in the treatment.

In an embodiment, the treatment fluids as disclosed herein exhibit a reduction in fluid viscosity as a function of shear rate of about 10% to about 50% relative to a reference fluid that does not contain the solvent and the secondary particles at temperatures between about −40° F. and about 550° F.

Other reduced rheological properties include reduced yield point, reduced gel strength, and the like as compared to a reference fluid that does not contain the solvent or the secondary particles. The reduced rheological properties make it easier to handle the treatment fluids in a commercial setting.

Downhole treatment fluids having reduced rheological properties can be made by first dispersing nano-sized secondary particles in a solvent to provide a modifier fluid or modifier suspension. The weight ratio of the secondary particles relative to the solvent is about 1:20 to about 20:1, about 1:10 to about 10:1 or about 1:1 to about 1:20, or about 1:1 to about 1:10, or about 1:2 to about 1:6. The modifier fluid or suspension is then mixed with micron-sized primary particles. During mixing, the solvent coats the primary particles and the secondary particles are disposed on a surface of the primary particles to provide modified primary particles. As used herein, “coat” means forming a membrane or absorbed into a surface layer of the primary particles. The modified primary particles can be incorporated into a treatment fluid that contains a carrier fluid which is immiscible with the solvent to reduce the rheological properties of the treatment fluids. A dispersing agent as disclosed herein, if present, can be incorporated into the modifier fluids/suspensions and/or directed added to the final treatment fluids.

In another embodiment, a first fluid and a second fluid are prepared separately wherein the first fluid comprises a liquid carrier and a plurality of micron-sized primary particles and the second fluid comprises a solvent which is immiscible with the liquid carrier of the first fluid and nano-sized secondary particles. Then the second fluid is combined with the first fluid. After mixing, the solvent coats the primary particles and the nano-sized secondary particles are disposed on a surface of the primary particles thus reducing the rheological properties of the first fluid. A dispersing agent as disclosed herein, if present, can be incorporated into the first fluid, the second fluid, or both.

The treatment fluids can be used in various applications. A method of treating a wellbore, a subterranean formation, or a combination thereof comprises introducing into the wellbore, the subterranean formation, or a combination thereof the treatment fluid. Any known methods of introducing treatment fluids into the wellbore can be used. Exemplary methods include pressure pumping. The treatment fluids can be applied in a continuous or batch injection process.

Prior to, simultaneously, or after introducing the treatment fluid, a wellbore operation can be conducted. Such operations include drilling operations, completion operations, workover operations, abandonment operations, or a combination comprising at least one of the foregoing.

In an embodiment, the downhole operation is a drilling operation, and a method of drilling a wellbore in a subterranean formation comprises circulating a treatment fluid as disclosed herein such as a drilling fluid or a drill-in fluid in the subterranean formation. The circulation path of the drilling or drill-in fluid typically extends from the drilling rig down through the drill pipe string to the bit face and back up through the annular space between the drill pipe string and wellbore face to the wellhead and/or riser, returning to the rig.

In another embodiment, the treatment fluid is a gravel pack fluid that further includes a gravel known in the art. A method of forming a gravel pack includes carrying a gravel into a subterranean formation with the treatment fluid, placing the gravel adjacent the subterranean formation to form a fluid permeable pack which is capable of reducing or substantially preventing the passage of formation fines from the subterranean formation into a wellbore while allowing passage of formation fluids from the subterranean formation into the wellbore.

Set forth below are various embodiments of the disclosure.

Embodiment 1. A method of treating a wellbore, a subterranean formation, or a combination thereof, the method comprising: introducing into the wellbore, the subterranean, or a combination thereof a treatment fluid comprising: a liquid carrier; a plurality of micron-sized primary particles; a plurality of nano-sized secondary particles disposed on a surface of the primary particles; and a solvent that is immiscible with the liquid carrier and coats the primary particles; the secondary particles and the solvent being selected such that the treatment fluid has a reduced rheological property as compared to an otherwise identical reference fluid that does not contain the solvent or the secondary particles; and performing a drilling operation, a completion operation, a workover operation, an abandonment operation, or a combination comprising at least one of the foregoing.

Embodiment 2. The method of as in any prior embodiment, wherein the treatment fluid further comprises a dispersing agent.

Embodiment 3. The method of Embodiment 2, wherein the dispersing agent comprises an alkyl sulfosuccinate, a nonylphenoxy-poly(ethyleneoxy)ethanol, a polyethyleneglycol alkyl-(C₈₋₁₀)-ether, a polyacrylate, acrylate-sulfonate copolymer, a petroleum sulfonic acid derivative, a lignin sulfonic acid derivative, a naphthalene sulfonic acid derivative, a salt of the derivative, a formaldehyde condensate of the derivative, or a combination comprising at least one of the foregoing.

Embodiment 4. The method as in any prior embodiment, wherein the primary particles have an average particle size of about 5 microns to about 500 microns.

Embodiment 5. The method as in any prior embodiment, wherein the primary particles comprise barite, hematite, galena, ilmenite, siderite, calcium carbonate, or a combination comprising at least one of the foregoing.

Embodiment 6. The method as in any prior embodiment, wherein the primary particles are present in an amount of about 1 volume % to about 60 volume % based on the total volume of the treatment fluid.

Embodiment 7. The method as in any prior embodiment, wherein the secondary particles have an average particle size of about 5 nanometers to about 500 nanometers.

Embodiment 8. The method as in any prior embodiment, wherein the secondary particles comprise inorganic carbonate nanoparticles, carbonaceous nanoparticles, metal oxide nanoparticles, ceramic nanoparticles, composite nanoparticles, or a combination comprising at least one of the foregoing.

Embodiment 9. The method as in any prior embodiment, wherein the secondary particles are present in an amount of about 0.001 wt % to about 15 wt % based on the total weight of the treatment fluid.

Embodiment 10. The method as in any prior embodiment, wherein the liquid carrier comprises water and the solvent comprises an oil.

Embodiment 11. The method as in any prior embodiment, wherein the oil comprises a diesel oil, a paraffin oil, a natural oil, a mineral oil, a crude oil, a gas oil, kerosene, an aliphatic solvent, an aromatic solvent, a synthetic oil, or a combination comprising at least one of the foregoing.

Embodiment 12. The method as in any prior embodiment, wherein the liquid carrier comprises an oil and the solvent comprises water.

Embodiment 13. The method as in any prior embodiment, wherein the treatment fluid is a drilling fluid, a drill-in fluid, a fracturing fluid, a servicing fluid, or a gravel pack fluid.

Embodiment 14. The method as in any prior embodiment, wherein the treatment fluid is a drilling fluid or a drill-in fluid, and the method further comprises circulating the treatment fluid in the subterranean formation.

Embodiment 15. The method as in Embodiment 14, further comprising sweeping drill cuttings to the surface of the wellbore with the treatment fluid.

Embodiment 16. The method as in any prior embodiment, wherein the treatment fluid is a gravel pack fluid that further comprises a gravel.

Embodiment 17. The method of Embodiment 16 further comprising forming a gravel pack with the gravel carried into the subterranean formation by the treatment fluid.

Embodiment 18.A downhole treatment fluid having a reduced rheological property comprising: a liquid carrier; a plurality of micron-sized primary particles; a plurality of nano-sized secondary particles disposed on a surface of the primary particles; and a solvent that is immiscible with the liquid carrier and coats the primary particles, wherein the treatment fluid is a drilling fluid, a drill-in fluid, a fracturing fluid, a servicing fluid, or a gravel pack fluid; and the secondary particles and the solvent are selected such that the treatment fluid has a reduced rheological property as compared to an otherwise identical reference fluid that does not contain the solvent or the secondary particles.

Embodiment 19. The downhole treatment fluid as in any prior embodiment, wherein the treatment fluid further comprises a dispersing agent.

Embodiment 20. The downhole treatment fluid as in any prior embodiment, wherein the primary particles comprise barite, hematite, galena, ilmenite, siderite, calcium carbonate, or a combination comprising at least one of the foregoing; and the primary particles are present in an amount of about 1 volume % to about 60 volume % based on the total volume of the treatment fluid.

Embodiment 21. The downhole treatment fluid as in any prior embodiment, wherein the secondary particles comprise inorganic carbonate nanoparticles, carbonaceous nanoparticles, metal oxide nanoparticles, ceramic nanoparticles, or a combination comprising at least one of the foregoing; and the secondary particles are present in an amount of about 0.001 wt. % to about 15 wt. % based on the total weight of the treatment fluid.

Embodiment 22. The downhole treatment fluid as in any prior embodiment, wherein the liquid carrier comprises water and the solvent comprises an oil.

Embodiment 23. The downhole treatment fluid as in any prior embodiment, wherein the liquid carrier comprises an oil and the solvent comprises water.

Embodiment 24. A method of reducing a rheological property of a downhole treatment fluid, the method comprising: combing a first fluid with a solvent and a plurality of nano-sized secondary particles, the first fluid comprising a plurality of micron-sized primary particles and a liquid carrier which is immiscible with the solvent; coating the primary particles with the solvent; and disposing the secondary particles on a surface of the primary particles, wherein the treatment fluid is a drilling fluid, a drill-in fluid, a fracturing fluid, a servicing fluid, or a gravel pack fluid; and the secondary particles and the solvent are selected such that the treatment fluid has a reduced rheological property as compared to an otherwise identical reference fluid that does not contain the solvent or the secondary particles.

Embodiment 25. The method of Embodiment 24, further comprising combining the secondary particles with the solvent to provide a second fluid and adding the second fluid to the first fluid.

Embodiment 26. A method of reducing a rheological property of a downhole treatment fluid, the method comprising: contacting a plurality of micron-sized primary particles with a solvent and a plurality of nano-sized secondary particles; coating the primary particles with the solvent; disposing the secondary particles on a surface of the primary particles to provide a modifier composition; combining the modifier composition with a liquid carrier immiscible with the solvent to form a downhole treatment fluid which is a drilling fluid, a drill-in fluid, a fracturing fluid, a servicing fluid, or a gravel pack fluid; wherein the secondary particles and the solvent are selected such that the treatment fluid has a reduced rheological property as compared to an otherwise identical reference fluid that does not contain the solvent or the secondary particles.

All ranges disclosed herein are inclusive of the endpoints, and the endpoints are independently combinable with each other. As used herein, “combination” is inclusive of blends, mixtures, alloys, reaction products, and the like. All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” The modifier “about” used in connection with a quantity is inclusive of the stated value and has the meaning dictated by the context (e.g., it includes the degree of error associated with measurement of the particular quantity). As used herein, the size or average size of the particles refers to the largest dimension of the particles and can be determined by high resolution electron or atomic force microscope technology. Average particle size means number average particle size.

What is claimed is:

1. A method of treating a wellbore, a subterranean formation, or a combination thereof, the method comprising:
introducing into the wellbore, the subterranean, or a combination thereof a treatment fluid comprising:
a liquid carrier;
a plurality of micron-sized primary particles;
a plurality of nano-sized secondary particles disposed on a surface of the primary particles; and
a solvent that is immiscible with the liquid carrier and coats the primary particles;
the secondary particles and the solvent being selected such that the treatment fluid has a reduced rheological property as compared to an otherwise identical reference fluid that does not contain the solvent or the secondary particles; and
performing a drilling operation, a completion operation, a workover operation, an abandonment operation, or a combination comprising at least one of the foregoing.

2. The method of claim 1, wherein the treatment fluid further comprises a dispersing agent.

3. The method of claim 2, wherein the dispersing agent comprises an alkyl sulfosuccinate, a nonylphenoxy-poly(ethyleneoxy)ethanol, a polyethyleneglycol alkyl-(C₈₋₁₀)-ether, a polyacrylate, acrylate-sulfonate copolymer, a petroleum sulfonic acid derivative, a lignin sulfonic acid derivative, a naphthalene sulfonic acid derivative, a salt of the derivative, a formaldehyde condensate of the derivative, or a combination comprising at least one of the foregoing.

4. The method of claim 1, wherein the primary particles have an average particle size of about 5 microns to about 500 microns.

5. The method of claim 1, wherein the primary particles comprise barite, hematite, galena, ilmenite, siderite, calcium carbonate, or a combination comprising at least one of the foregoing.

6. The method of claim 1, wherein the primary particles are present in an amount of about 1 volume % to about 60 volume % based on the total volume of the treatment fluid.

7. The method of claim 1, wherein the secondary particles have an average particle size of about 5 nanometers to about 500 nanometers.

8. The method of claim 1, wherein the secondary particles comprise inorganic carbonate nanoparticles, carbonaceous nanoparticles, metal oxide nanoparticles, ceramic nanoparticles, composite nanoparticles, or a combination comprising at least one of the foregoing.

9. The method of claim 1, wherein the secondary particles are present in an amount of about 0.001 wt % to about 15 wt % based on the total weight of the treatment fluid.

10. The method of claim 1, wherein the liquid carrier comprises water and the solvent comprises an oil.

11. The method of claim 10, wherein the oil comprises a diesel oil, a paraffin oil, a natural oil, a mineral oil, a crude oil, a gas oil, kerosene, an aliphatic solvent, an aromatic solvent, a synthetic oil, or a combination comprising at least one of the foregoing.

12. The method of claim 1, wherein the liquid carrier comprises an oil and the solvent comprises water.

13. The method of claim 1 wherein the treatment fluid is a drilling fluid, a drill-in fluid, a fracturing fluid, a servicing fluid, or a gravel pack fluid.

14. The method of claim 1, wherein the treatment fluid is a drilling fluid or a drill-in fluid, and the method further comprises circulating the treatment fluid in the subterranean formation.

15. The method of claim 14, further comprising sweeping drill cuttings to the surface of the wellbore with the treatment fluid.

16. The method of claim 1, wherein the treatment fluid is a gravel pack fluid that further comprises a gravel.

17. The method of claim 16 further comprising forming a gravel pack with the gravel carried into the subterranean formation by the treatment fluid.

18. A downhole treatment fluid having a reduced rheological property comprising:
a liquid carrier;
a plurality of micron-sized primary particles;
a plurality of nano-sized secondary particles disposed on a surface of the primary particles; and
a solvent that is immiscible with the liquid carrier and coats the primary particles,
wherein the treatment fluid is a drilling fluid, a drill-in fluid, a fracturing fluid, a servicing fluid, or a gravel pack fluid; and the secondary particles and the solvent are selected such that the treatment fluid has a reduced rheological property as compared to an otherwise identical reference fluid that does not contain the solvent or the secondary particles.

19. The downhole treatment fluid of claim 18, wherein the treatment fluid further comprises a dispersing agent.

20. The downhole treatment fluid of claim 18, wherein the primary particles comprise barite, hematite, galena, ilmenite, siderite, calcium carbonate, or a combination comprising at least one of the foregoing; and the primary particles are present in an amount of about 1 volume % to about 60 volume % based on the total volume of the treatment fluid.

21. The downhole treatment fluid of claim 18, wherein the secondary particles comprise inorganic carbonate nanoparticles, carbonaceous nanoparticles, metal oxide nanoparticles, ceramic nanoparticles, or a combination comprising at least one of the foregoing; and the secondary particles are present in an amount of about 0.001 wt. % to about 15 wt. % based on the total weight of the treatment fluid.

22. The downhole treatment fluid of claim 18, wherein the liquid carrier comprises water and the solvent comprises an oil.

23. The downhole treatment fluid of claim 18, wherein the liquid carrier comprises an oil and the solvent comprises water.

24. A method of reducing a rheological property of a downhole treatment fluid, the method comprising:
combing a first fluid with a solvent and a plurality of nano-sized secondary particles, the first fluid comprising a plurality of micron-sized primary particles and a liquid carrier which is immiscible with the solvent;
coating the primary particles with the solvent; and
disposing the secondary particles on a surface of the primary particles,
wherein the treatment fluid is a drilling fluid, a drill-in fluid, a fracturing fluid, a servicing fluid, or a gravel pack fluid; and the secondary particles and the solvent are selected such that the treatment fluid has a reduced rheological property as compared to an otherwise identical reference fluid that does not contain the solvent or the secondary particles.

25. The method of claim 24, further comprising combining the secondary particles with the solvent to provide a second fluid and adding the second fluid to the first fluid.

26. A method of reducing a rheological property of a downhole treatment fluid, the method comprising:
contacting a plurality of micron-sized primary particles with a solvent and a plurality of nano-sized secondary particles;
coating the primary particles with the solvent;
disposing the secondary particles on a surface of the primary particles to provide a modifier composition;
combining the modifier composition with a liquid carrier immiscible with the solvent to form a downhole treatment fluid which is a drilling fluid, a drill-in fluid, a fracturing fluid, a servicing fluid, or a gravel pack fluid;
wherein the secondary particles and the solvent are selected such that the treatment fluid has a reduced rheological property as compared to an otherwise identical reference fluid that does not contain the solvent or the secondary particles.
